(19) United States
(12) Patent Application Publication
(10) Pub. No.: US 2008/0174435 A1
(43) Pub. Date: Jul. 24, 2008

(54) RFID assembly

(76) Inventor: Wen-Cheng Yin, Taipei Hsien (TW)

Correspondence Address: Wen-Cheng Yin, 235 Chung -Ho, Box 8-24, Taipei, omitted

(21) Appl. No.: 11/657,987

(22) Filed: Jan. 23, 2007

(51) Int. Cl. G08B 13/14

(52) U.S. Cl. 340/572.7

(57) ABSTRACT

An RFID assembly comprises an RFID substrate having an antenna coil, a chip set, a first joint and a second joint; the antenna coil being installed to the RFID substrate; the chip set being electrically connected to the antenna coil; one end of the first joint being connected to the second joint; and another end of the first joint being connected to another end of the second joint through a conductor material so as to form as an electric loop; when the RFID substrate moves into the detection range of a reader so as to actuate the chip set of the RFID substrate; meanwhile, the antenna coil of the RFID substrate will return a react signal to a receiving unit of the reader; a combining sheet being an adhesive film or an adhesive agent; the combining sheet being a single face or a double face gluing file.

### FIELD OF THE INVENTION

The present invention relates to RFID, and particularly to a combining assembly of an RFID, wherein the RFID assembly cam be combined with communication devices so as to enlarge the applications of the communication devices and electronic devices for using in business, parking, shopping, identification, stock management, transaction, etc.

### BACKGROUND OF THE INVENTION

In the prior art portable cards (such as sensitive cards, smart cards, or plastic cards), an RFID label is installed therein. The label is implanted with a chip set and an antenna coil. The chip set is electrically connected to the antenna coil. The chip set is burned with programs or cards for identifying the cards. The antenna coil serves to transmit signals between the label and a reader. When the label enters into a range detectable by the reader, a wireless identification system will provide a steady signal source. The antenna coil will induce a current so as to actuate the chip set. Meanwhile the codes of the label will be transmitted out through the antenna coil. Then the codes are ordered by the receiving end and identified so as to make required processes.

However the prior art RFID label can not be combined with other devices and have dull appearances which are not suit for current trends.

### SUMMARY OF THE INVENTION

Accordingly, the primary object of the present invention is to provide a combining assembly of an RFID, wherein the RFID assembly can be combined with communication devices so as to enlarge the applications of the communication devices and electronic devices for using in business, parking, shopping, identification, stock management, transaction, etc.

To achieve above object, the present invention provides an RFID assembly which comprises RFID substrate having an antenna coil, a chip set, a first joint and a second joint; the antenna coil being installed to the RFID substrate; the chip set being electrically connected to the antenna coil; one end of the first joint being connected to the second joint; and another end of the first joint being connected to another end of the second joint through a conductor material so as to form as an electric loop; when the RFID substrate moves into the detection range of a reader so as to actuate the chip set of the RFID substrate; meanwhile, the antenna coil of the RFID substrate will return a react signal to a receiving unit of the reader; a combining sheet being an adhesive film or an adhesive agent; the combining sheet being a single face or a double face gluing file; the combining sheet being installed to a RFID substrate or an electromagnetic-preventing material; the combining sheet being used as a combination structure; the electromagnetic-preventing material being a film like compound; the electromagnetic-preventing material being installed on the RFID substrate through the combining sheet; the electromagnetic-preventing material being used to prevent the dispersing of electromagnetic wave and isolating electromagnetic wave to harm human bodies; the electromagnetic-preventing material being a material for preventing electromagnetic wave interference and anti-static electricity.

The various objects and advantages of the present invention will be more readily understood from the following detailed description when read in conjunction with the appended drawing.

### BRIEF DESCRIPTION OF THE DRAWINGS

FIG. 1 is an explosive schematic view of the present invention.

FIG. 2 is a perspective view of the present invention.

FIG. 3 is an explosive schematic view of RFID substrate of the present invention.

FIG. 4 is a circuit schematic view about the connection of the RFID substrate and the chipset of the present invention.

FIG. 5 is a schematic view showing the first application of the present invention.

FIG. 6 is a schematic view showing the second application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

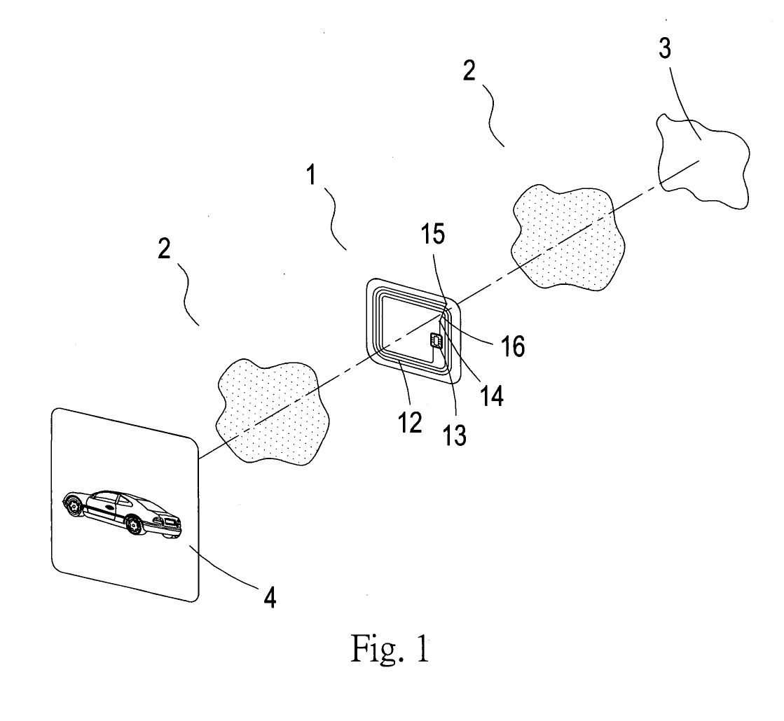

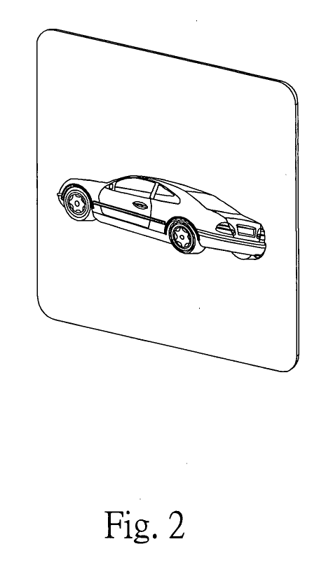

With referring to FIGS. 1 and 2, an embedding assembly of a wireless radio frequency identification label according to the present invention is illustrated. The present invention has the following elements.

An RFID substrate 1 has an antenna coil 12, a chip set 13, a first joint 14 and a second joint 15. The antenna coil 12 is installed to the RFID substrate 1 by etching, winding, printing or coating. The chip set 13 is electrically connected to the antenna coil 12. The first joint 14 is connected to the second joint 15 through a conductor material 16. The first joint 14 and second joint 15 can be installed at two sides of the RFID substrate 1 and the first joint 14 is directly connected to the second joint 15 so as to form as an electric loop. The RFID substrate 1 can be built with a power source as an active label. Thereby the present invention can monitor environment by the interior energy thereof. Thus, when the RFID substrate 1 moves into the detection range of a reader so as to actuate the chip set 13 of the RFID substrate 1, the antenna coil 12 of the RFID substrate 1 will return a react signal to a receiving unit of the reader. A combining sheet 2 is an adhesive film or an adhesive agent. The combining sheet 2 may be a single face or a double face gluing file. The combining sheet 2 can be directly installed to a RFID substrate 1 or an electromagnetic-preventing material 3. The combining sheet 2 is used as a combination structure for the RFID substrate 1, electromagnetic-preventing material 3 and other connection device (not shown). The combining sheet 2 may be a single face or a double face structure.

An electromagnetic-preventing material 3 is a film like compound. The electromagnetic-preventing material 3 is installed on the RFID substrate 1 through the combining sheet 2. The electromagnetic-preventing material 3 is used to prevent the dispersing of electromagnetic wave and isolating electromagnetic wave to harm human bodies. The electromagnetic-preventing material 3 is a material for preventing electromagnetic wave interference and anti-static electricity.

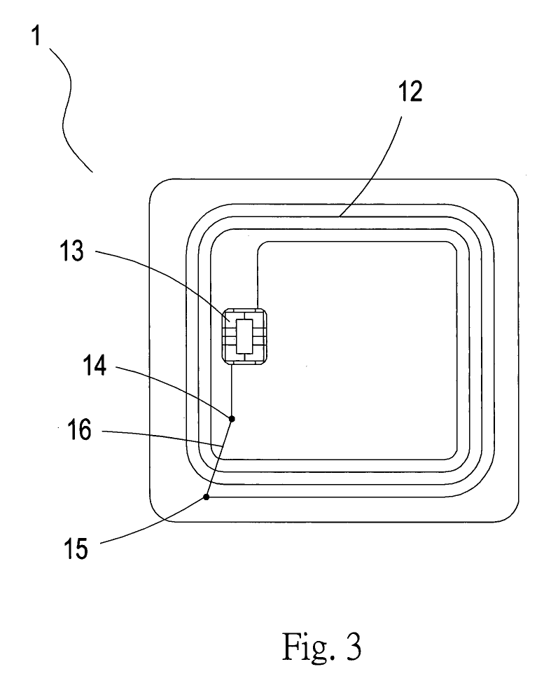

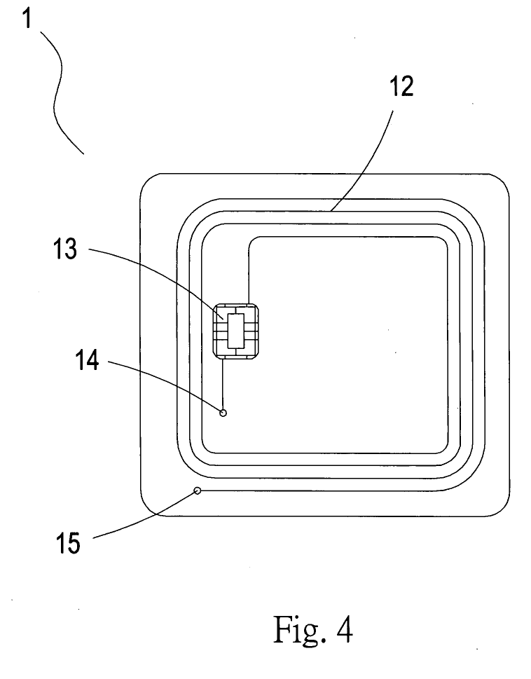

With referring to FIGS. 3 and 4, the antenna coil 12 is electrically connected to the chip set 13. One end of he first joint 14 of the antenna coil 12 is connected to one end of the second joint 15. Another end of the first joint 14 is connected to another end of the second joint 15 through the conductor material 16 so as to form an electric loop. The antenna coil 12 and the chip set 13 are installed at a surface of the RFID substrate 1. In the present invention, the first joint 14 and second joint 15 can be installed at the same surface by coating insulating glue therebetween and then the conductor material 16 are jump through the insulting glue to connect the first joint 14 to the second joint 15. Or the first joint 14 and second joint 15 are installed at two different surfaces of the RFID substrate 1 and the RFID substrate 1 is formed with a penetrating hole. The conductor material 16 passes through the penetrating hole to connect the first joint 14 and second joint 15.

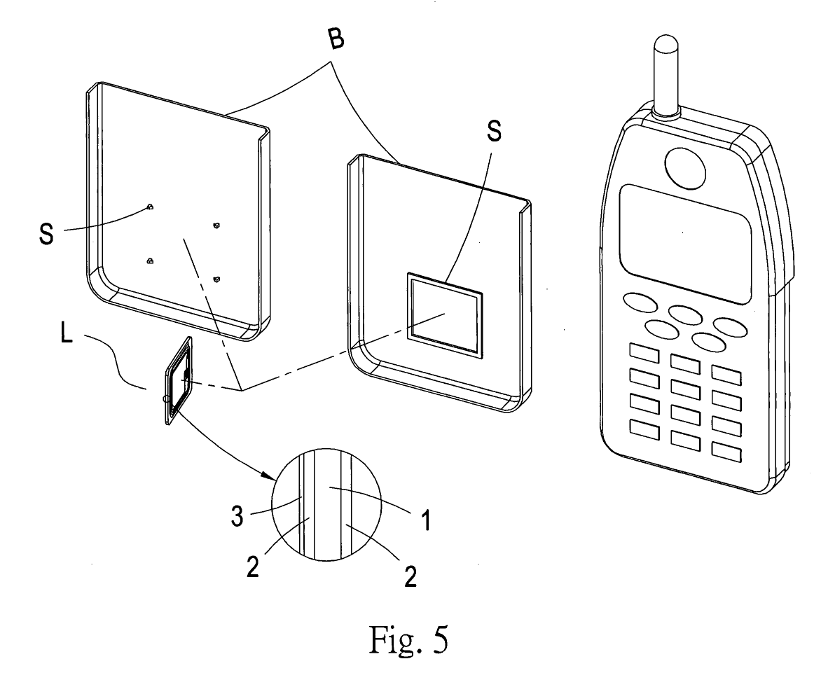

Referring to FIG. 5, an application of the present invention is illustrated. In that the RFID substrate 1 of the present invention is embedded into a trench S of a handset casing. The electromagnetic-preventing material 3 has the effect of preventing electromagnetic wave of the handset to drain out. In application, the handset back cover B facing to the battery is formed with the trench S. A RF identification label L is installed in the trench S, as illustrated in the drawing. In assembly, two lateral surfaces of the RFID substrate 1 with an exposed antenna coil 12 are installed with respective combining sheets 2. One side of the RFID substrate 1 is installed with an electromagnetic-preventing material 3. The surface having the electromagnetic-preventing material 3 faces toward the battery of the handset. Moreover, another side of the RFID substrate 1 is adhered to the handset back cover B or the embedded RF identification label L is installed in a hook. Thus, by WAP or GPRS of the handset, the RF identification label L has a wide sensing range and the handset has provided with the functions of multiple cards.

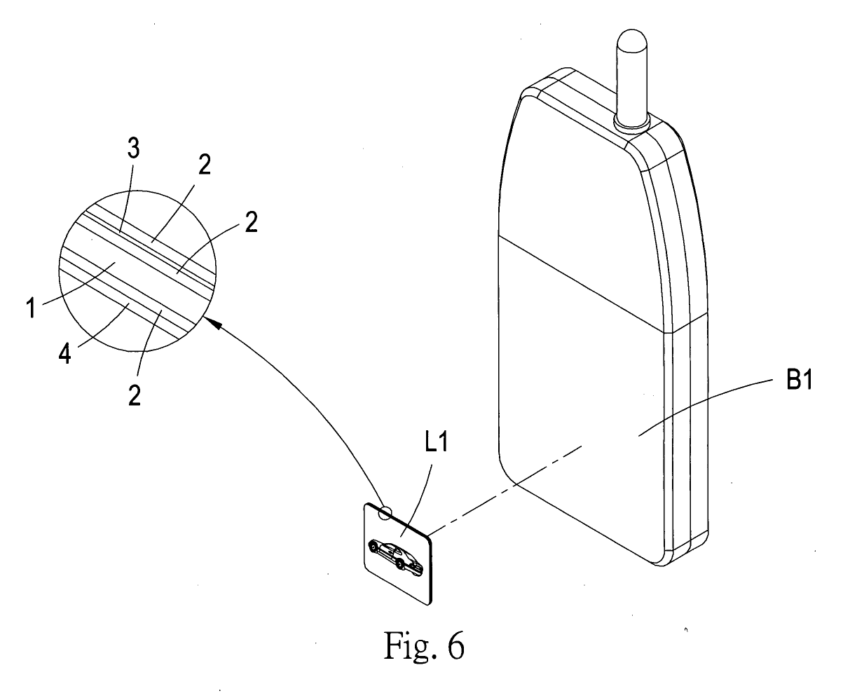

Referring to FIG. 6, another application of the present invention is illustrated. An RF identification label plate L1 is adhered to the handset casing backside B1. In that, one side of the RFID substrate 1 is installed with a combining sheet 2. A panel 4 with pattern or without pattern thereon is adhered to the combining sheet 2. Another side of the RFID substrate 1 is installed with a combining sheet 2. Then a layer of electromagnetic-preventing material 3 is installed upon the combining sheet 2 and then another combining sheet 2 is installed upon the electromagnetic-preventing material 3. Thus the RF identification label L and the handset are formed as an integral body. Thus other than as a communication unit, the RF identification label L1 can be used as an indication plate by the pattern on the panel 4.

Advantages of the present invention are that: by the present invention, the RF identification label can be combined with the WAP and GPRS mechanism of communication units or electronic device, so as to enlarge the application of RFID. Furthermore, one handset has a plurality of RFID functions.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An RFID assembly, comprise:
an RFID substrate having an antenna coil, a chip set, a first joint and a second joint; the antenna coil being installed to the RFID substrate; the chipset being electrically connected to the antenna coil; one end of the first joint being connected to the second joint; and another end of the first joint being connected to another end of the second joint through a conductor material so as to form as an electric loop; when the RFID substrate moves into a detection range of a reader to actuate the chip set of the RFID substrate, the antenna coil of the RFID substrate will return a react signal to a receiving unit of the reader;
a combining sheet being an adhesive film or an adhesive agent; the combining sheet being a single face or a double face gluing file; the combining sheet being installed to a RFID substrate or an electromagnetic-preventing material; the combining sheet being used as a combination structure;
the electromagnetic-preventing material being a film like compound; the electromagnetic-preventing material being installed on the RFID substrate through the combining sheet; the electromagnetic-preventing material being used to prevent the dispersing of electromagnetic wave and isolating electromagnetic wave to harm human bodies; the electromagnetic-preventing material being a material for preventing electromagnetic wave interference and anti-static electricity.

2. The RFID assembly as claimed in claim 1, wherein the antenna coil 12 is installed to the RFID substrate 1 by etching, winding, printing or coating.

3. The RFID assembly as claimed in claim 1, wherein the RFID substrate 1 can be built with a power source as an active label.

4. The RFID assembly as claimed in claim 1, wherein at least one combining sheet is used.

5. The RFID assembly as claimed in claim 1, wherein the electromagnetic-preventing material is a compound and has the effect of electromagnetic wave preventing and anti-static electricity.

6. The RFID assembly as claimed in claim 2, wherein the first joint and second joint are installed at the same surface by coating insulating glue therebetween and then the conductor material are jump through the insulting glue to connect the first joint to the second joint.

7. The RFID assembly as claimed in claim 1, wherein the first joint and second joint are installed at two different surfaces of the RFID substrate and the RFID substrate is formed with a penetrating hole; the conductor material passing through the penetrating hole to connect the first joint to the second joint.

8. An RFID assembly for a handset, an RFID substrate being embedded into a trench of a handset casing; a handset back cover facing to a battery thereof being formed with the trench; an RF identification label being installed in the trench; two sides of the RFID substrate with an exposed antenna coil being installed with respective combining sheets; one side of the RFID substrate being installed with an electromagnetic-preventing material upon the combining sheet; the surface having the electromagnetic-preventing material facing to the battery of the handset; another side of the RFID substrate being adhered to the handset back cover; wherein by WAP or GPRS of the handset, the RF identification label has a wide sensing range and the handset has provided with the functions of multiple cards.

9. The RFID assembly comprising: an RFID substrate; one side of the RFID substrate being installed with a first combining sheet; a panel with pattern or without pattern thereon being adhered to the first combining sheet; another side of the RFID substrate being installed with a second combining sheet; then a layer of electromagnetic-preventing material being installed upon the second combining sheet and then a third combining sheet being installed upon the electromagnetic-preventing material; thus the RF identification label and the handset being formed as an integral body; thus other than as an communication unit, the RF identification label L1 can be used as an indication plate by the pattern on the panel.
